(19) United States
(12) Patent Application Publication
(10) Pub. No.: US 2005/0181345 A1
(43) Pub. Date: Aug. 18, 2005

(54) Mentor based computer assisted learning

(75) Inventors: William H. Bradbury, San Jose, CA (US); Kanchan Wadhwa, Saratoga, CA (US)

Correspondence Address: BURNS DOANE SWECKER & MATHIS L L P, POST OFFICE BOX 1404, ALEXANDRIA, VA, 22313-1404, US

(73) Assignee: EduMedia Development Corporation, San Jose, CA (US)

(21) Appl. No.: 11/015,226

(22) Filed: Dec. 17, 2004

Related U.S. Application Data
(60) Provisional application No. 60/530,603, filed on Dec. 19, 2003.

(51) Int. Cl. G09B 7/00

(52) U.S. Cl. 434/322

(57) ABSTRACT

In accordance with the present invention there is provided an educational system implemented on a computer network that ensures the student is learning the material. The system has an educational server configured to monitor the progress between an instructor and a student. The educational server has a program that delivers educational material to a computer of the student. The program also receives student communications from the computer of the student. The educational server forwards the student communication to a computer of the instructor and delivers further educational materials to the computer of the student upon approval of the instructor.

### CROSS-REFERENCE TO RELATED APPLICATIONS

This application claims the benefit of U.S. Provisional Application No. 60/530,603, filed Dec. 19, 2003, the contents of which are incorporated by reference herein.

### FIELD OF THE INVENTION

The present invention generally relates to computer assisted learning systems and more specifically to a system and method for a computer assisted learning system that ensures the student is learning the material.

### BACKGROUND OF THE INVENTION

Computer assisted learning systems enable a student to remotely learn material at his or her own pace. In such systems, the student is presented lectures, texts, and other information either in hard copy or as a presentation on the computer. The student can review the materials at his or her own pace, or at a pace dictated by the computer. In these prior art systems, after the student has reviewed the materials, the computer tests the student. Typically, the tests are in the form of multiple choice and true false tests that are easily graded by the computer.

In the typical computer assisted learning system, the student's progress is monitored automatically by the computer system by reviewing test scores. By reviewing the scores, it is possible to determine whether the student is learning the material. However, this method is limited by the type of tests that can be administered to the student to monitor progress.

Specifically, only computer graded tests can be administered to the students. In this regard, only simple tests containing true/false and multiple choice questions can be given to the students. These type of tests limit the ability to accurately judge the learning comprehension of the student.

In many subject areas, true/false and multiple choice testing cannot accurately judge how much the student learns. For example, if the student is studying electrical circuit design, it is preferable to test the student's ability to design circuits rather than ask him true/false and multiple choice questions. By having the student actually design an electrical circuit, it is possible to determine whether the student is actually understanding the basic concepts needed. Multiple choice and true/false tests cannot accurately judge the student's comprehension of the material.

The present invention addresses the above-mentioned deficiencies in computer-assisted teaching systems by providing a system and method that ensures students are learning the material by providing the proper tests and exercises. Furthermore, the present invention provides an interactive teaching method using the computer that ensures the student is learning the material.

### SUMMARY OF THE INVENTION

In accordance with the present invention there is provided an educational system implemented on a computer network that ensures the student is learning the material. The system has an educational server configured to monitor the progress between an instructor and a student. The educational server has a program that delivers educational material to a computer of the student. The program also receives student communications from the computer of the student. The educational server forwards the student communication to a computer of the instructor and delivers further educational materials to the computer of the student upon approval of the instructor.

Typically, the educational materials contain lectures and exercises for the student to perform. The student answers the exercises and returns them to the instructor in the student communication. If the student answers the exercises correctly, then the educational server delivers further educational material. However, if the instructor determines that the student did not answer the exercises correctly, the student will not receive further educational materials.

The educational server is also configured to ensure that the instructor is available to review the student communication. If the instructor is not available, the educational server will assign a backup instructor to the student who will review the student's exercise. The educational material may include video lectures that the student can view at his own schedule.

### BRIEF DESCRIPTION OF THE DRAWINGS

These, as well as other features of the present invention, will become more apparent upon reference to the drawings wherein:

FIG. 1 is a diagram illustrating a system for mentor based computer assisted learning; and

FIG. 2 is a flowchart illustrating the steps for mentor based computer assisted learning.

### DETAILED DESCRIPTION

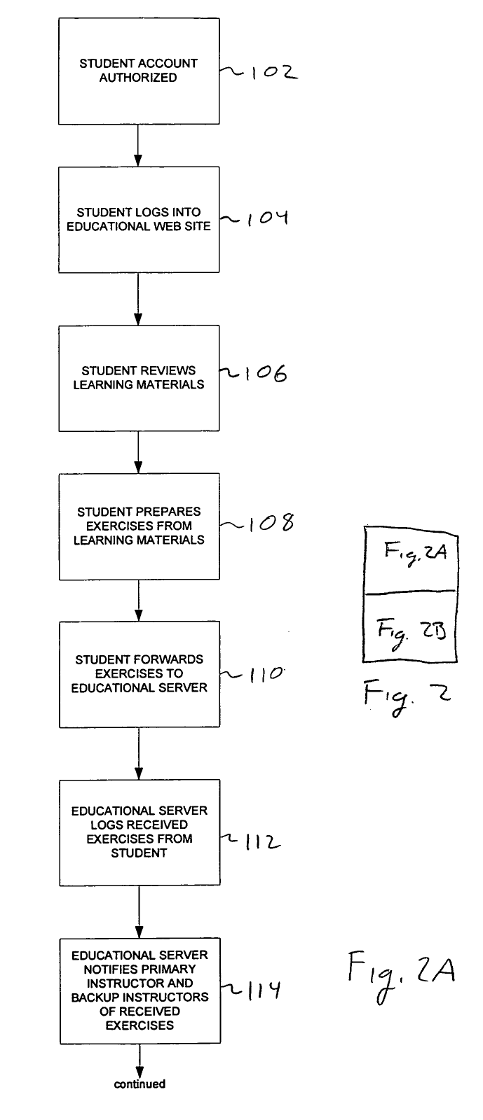

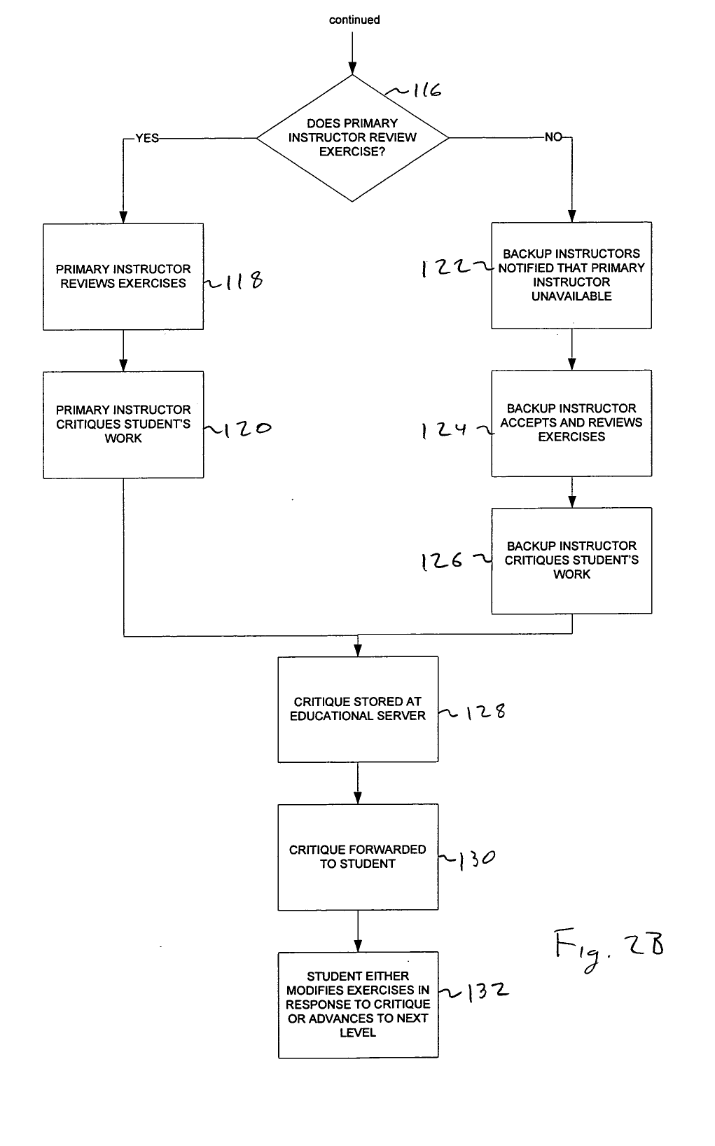

Various aspects will now be described in connection with exemplary embodiments, including certain aspects described in terms of sequences of actions that can be performed by elements of a computer system. For example, it will be recognized that in each of the embodiments, the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described. The instructions of a computer program as illustrated in FIG. 2 for mentor based computer assisted learning can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non exhaustive list) of the computer readable-medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

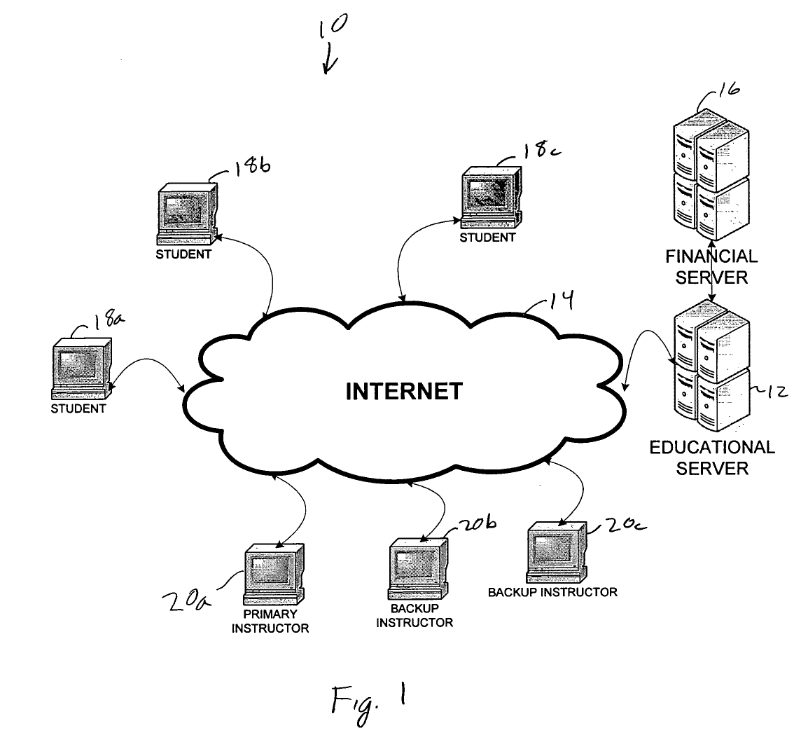

Referring now to the drawings wherein the showings are for purposes of illustrating preferred embodiments of the present invention only, and not for purposes of limiting the same, FIG. 1 illustrates a system 10 for mentor based computer assisted learning. The system 10 includes an educational server 12 that is connected to the Internet 14. The educational server 12 is one or more servers configured to generate web pages and applications that assist students in the learning process. The educational server 12 can be a series of mirrored or replicated servers placed at different locations. The educational server 12 may include a web server to generate web pages and a streaming media server to present instructional materials. The educational server 12 is connected to a financial server 16 that maintains the financial records of the students in order to determine if the students have paid fees and are properly enrolled in the correct course. The system 10 further includes student computers 18a, 18b, 18c connected to the Internet 14 that communicate with the educational server 12. In this respect, the educational server 12 provides the student computers 18 with educational materials that are used by the students operating the student computers 18. Also connected to the Internet 14 are instructor computers 20 used by instructors (i.e., mentors) to assist the students in learning. As shown in FIG. 1, instructor computer 20a is for a primary instructor, while computers 20b and 20c are for backup instructors. It will be recognized by those of ordinary skill in the art that the number of student computers 18 and instructor computers 20 can vary from the number shown in FIG. 1.

The educational server 12 manages assignments between the students and the instructors, distributes class lectures and communications, archives all communications and data, and tracks instructor's time with each student. The educational server 12 can receive daily updates about new students and existing students. Such information may come from the financial server 16. The educational server 12 also selects and assigns primary and backup instructors for each new student or reassigns and removes instructors when needed. The selections may be based on a list of potential primary and backup instructors for each class type and availability based on work load.

In order to ensure that the student can receive educational materials, the educational server 12 verifies the student's logon for a specific class and communication based on daily updates from the financial server 16. The educational server 12 authorizes the watching of chapter lectures by the student when appropriate. As will be further explained below, the educational server 12 will allow a student to watch a lecture or receive educational materials only when authorized by the student's instructor. The educational server 12 records the materials sent to the student, as well as archives, dates and time stamps all communications and exercises between the student and instructor.

In order to ensure that the student can contact an instructor, the educational server 12 notifies a primary instructor that the student has a communication. The educational server 12 will record the time that it takes for the primary instructor to respond. If the primary instructor does not respond, then the educational server 12 notifies a backup instructor that the student has a communication. If the backup instructor accepts the communication, the educational server notifies other instructors that the communication has been accepted and that further action by the other instructors is not needed. Once the communication has been accepted by either the primary or backup instructor, the educational server 12 records the elapsed time the instructor spends on the response for the student. If the instructor (either primary or backup) releases the student to go on to the next chapter and receive further learning materials, the educational server 12 updates the learning log and notifies the student.

The educational server 12 can monitor the time instructors spend in responding to students and compare this to pre-established time models. If the time logged is outside the model, an instructor manager can be notified. The logging of time an instructor spends on responses per individual student can be used to determine hours worked for pay purposes. All instructors can be reviewed and compared monthly for time spent on responses and communications.

Each instructor (either primary or backup) reviews the assignments from the students and provides feedback and/or advances the student to the next chapter to receive additional learning materials. Specifically, the instructor reviews the communications from the students and provides comments. The communications provide the student's answers to exercises derived from the learning materials. The instructor reviews the student's exercises for completeness and quality in order to provide proper feedback. If the exercise is complete and the instructor deems the student thoroughly understands the material, the instructor can advance the student to the next chapter. All communications and responses between the student and instructor are monitored, archived and logged by the educational server 12. By retaining a copy of all communications and responses between a student and instructor, a backup instructor can become familiar with the student's work and provide the proper feedback quickly.

The student establishes an account with the educational server 12 in order to receive educational materials. The materials may include books and software that the student uses in conjunction with lectures provided by the educational server 12. The student accesses the web site of the educational server 12 and logs in for an introduction the first time. The student then receives additional learning materials as the student progresses through the course. The learning materials can be arranged into chapters containing multiple sections. After reviewing the materials in each chapter, the student is presented with exercises that the student must answer correctly in order to progress to the next chapter. The exercises are forwarded as a communication to the instructor for review. The student receives a response from the instructor and either modifies the answers and returns them to the instructor or advances to the next chapter if the exercises are correct.

Referring to FIG. 2, a flowchart showing the process of learning with the mentor based computer assisted learning system of FIG. 1 is shown. In step 102, the student's account is authorized by the financial server 16. In many instances a third party may be paying for the student's coursework. The system 10 allows a third party to monitor the students coursework and withhold payment for future classes if the student is not progressing satisfactorily.

Once the student has an authorized account, the student logs into the web site of the educational server 12 in step 104. The student is directed to the authorized class and instructional materials. In step 106, the student watches the chapter lecture delivered by the educational server 12. The chapter lecture may be streaming video and audio including captions presented in real-time. The lecture may also be used in conjunction with other materials such as software installed on the student's computer and textbooks. The student has the ability to review any of the material at any time. However, the student cannot proceed to chapters that are not yet authorized by his instructor. In this respect, the student can watch chapters he has already seen but not skip ahead.

Once the student is done reviewing the materials for the chapter, the student answers questions about the chapter in step 108. Specifically, the student will prepare answers to exercises based on the learning materials. The exercises will be questions that test the student's comprehension of the material and may be in the form of questions that cannot be easily graded automatically by a computer. For example, if the course is electrical circuit design, the student may be tested by designing logic. In such an exercise there may be more than one correct answer to the exercise. Accordingly, a computer cannot adequately grade the design. Another example would be for a literature class whereby the student writes an essay on the material he has read. In this instance, a computer cannot grade an essay with the same quality as a human being. Therefore, it would not be appropriate for a computer to grade these types of exercises.

After the student has prepared the answers to the exercises based on the learning materials, the students sends the completed exercises to the educational server 12 in step 110. The exercises are sent to the educational server 12 in the form of a student communication. The educational server 12 logs the received exercises from the student in step 112 for future reference. Furthermore, the educational server 12 records the time the communication is received, as well as checks the availability of instructors.

In step 114, the educational server 12 notifies the primary and backup instructors that a communication from the student has been received. Typically, the educational server 12 notifies two backup instructors that a communication has been received and that their assistance might be needed. The primary instructor has the ability to review the communication in step 116. If the primary instructor accepts the communication in step 116, then the process proceeds to step 118 where the primary instructor reviews the exercise. In step 120, the primary instructor provides a critique of the student's work to provide feedback. The critique is a response containing comments and or suggestions.

If the primary instructor does not review the exercise within a prescribed period of time in step 116, then the process proceeds to step 122 whereby the backup instructors are notified that the primary instructor did not accept the communication. In step 124, one of the backup instructors accepts the communication and the educational server 12 notifies the other backup instructors, (as well as the primary instructor) that no further action is needed on their part. If no instructor accepts the communication, then the manager of the system is notified in order to take action. In step 126, the backup instructor critiques the student's work in order to provide feedback. It is possible for the backup instructor to review the student's records on the educational server 12 in order to provide the proper feedback based on the student's learning history.

In step 128, the critique (either from the primary or backup instructor) is forwarded and stored at the educational server 12. The critique (or response) is then forwarded to the student in 130. The student may be notified that the critique is in their electronic in-basket by the educational server 12 or the critique may be directly sent to the student. In step 132, the student reviews the critique and either modifies the exercises in response to the instructor's feedback or proceeds to the next chapter if the exercise was in proper order. If the student modifies the exercise, then the exercise will be forwarded to the instructor again for further review. The student will not be allowed to proceed to the next chapter until the exercise is correct. In this regard, the instructor can control the pace of the student's learning and ensure that the student has properly learned the material.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. An educational system implemented on a computer network, comprising:
an educational server configured to monitor progress between an instructor and a student, the educational server containing a program which executes the following instructions:
deliver educational material to a computer of the student;
receive a student communication from the computer of the student;
forward the student communication to a computer of the instructor; and
deliver further educational materials to the computer of the student upon approval of the instructor in response to the student communication.

2. The system of claim 1 wherein the program further includes instructions for receiving a response from the computer of the instructor that the instructor has received the communication from the student.

3. The system of claim 2 wherein the program further includes instructions for forwarding the student communication to a backup instructor if the computer of the instructor does not transmit a response.

4. The system of claim 1 wherein the program further includes instructions for delivering an instructor response to the computer of the student if the further educational materials are not delivered.

5. The system of claim 1 wherein the program further includes instructions for delivering educational materials that are a video presentation.

6. A computer-readable medium comprising instructions that execute the following procedure:
delivering educational material from an educational server to computer of a student;
transmitting a student communication from the computer of the student to the educational server;
forwarding the student communication from the educational server to a computer of an instructor;
transmitting a response from the computer of the instructor to the computer of the student with the educational server; and
transmitting further educational materials to the computer of the student with the educational server upon approval of the instructor in response to the student communication.

7. The computer-readable medium of claim 6 further comprising instructions for receiving a response from the computer of the instructor indicating that the instructor has received the student communication.

8. The computer-readable medium of claim 7 further comprising instructions for delivering the student communication to a backup instructor if the response indicating that the instructor has received the student communication is not sent.

9. The computer-readable medium of claim 6 further comprising instructions for delivering educational materials that are a video presentation.

10. The computer-readable medium of claim 9 wherein the video presentation is a lecture.

11. The computer-readable medium of claim 6 further comprising instructions for forwarding the student communication to a backup instructor if the instructor is not available.

12. A method for providing educational materials to a student over a computer network, the method comprising the steps of:
delivering educational material from an educational server to a computer of the student;
transmitting a student communication from the computer of the student to the educational server;
forwarding the student communication from the educational server to a computer of an instructor;
transmitting a response from the computer of the instructor to the computer of the student with the educational server; and
transmitting further educational materials to the computer of the student with the educational server upon approval of the instructor in response to the student communication.

13. The method of claim 12 wherein the educational materials include exercises to test the ability of the student.

14. The method of claim 13 wherein the student communication includes answers to the exercises.

15. The method of claim 14 wherein the further educational materials are transmitted when the instructor approves the exercises from the student.

16. The method of claim 12 further comprising the step of transmitting the student communication to a backup instructor if the instructor is not available.

17. The method of claim 12 wherein the educational material is a video lecture.
